(19) United States
(12) Patent Application Publication
(10) Pub. No.: US 2003/0072328 A1
(43) Pub. Date: Apr. 17, 2003

(54) Framing data in a control circuit

(76) Inventors: Jesus Palomino Echartea, Zapopan (MX); Rogelio C. Gonzalez, Zapopan (MX)

Correspondence Address: FISH & RICHARDSON, PC, 4350 LA JOLLA VILLAGE DRIVE, SUITE 500, SAN DIEGO, CA, 92122, US

(21) Appl. No.: 09/978,949

(22) Filed: Oct. 15, 2001

(51) Int. Cl. H04J 3/00

(52) U.S. Cl. 370/470; 370/498

(57) ABSTRACT

A method includes receiving data from a series of network ports, transmitting the data to a first stage of a frame state machine, and determining if the data includes a key sequence. The method also includes moving the data from the first stage of the frame state machine to a second stage of the frame state machine if the data has the key sequence.

### TECHNICAL FIELD

This invention relates to framing data in a control circuit.

### BACKGROUND

A receiver of a bit stream determines if the data bit stream received is the same data bit stream that was transmitted. Typically, bit streams are broken into frames to simplify the process of determining if they contain any transmission errors. Some frames are separated from one another by inserting time gaps between the frames (i.e., like spaces between words in ordinary text). Many framing algorithms exist to assist in error code detection such as checksum, character count, etc.

To maximize the use of silicon, more semiconductor devices are being developed with a higher functional density. To increase the functional density, a logic function is simplified and/or the logic function is expressed more effectively in the silicon design. For example, random access memory (RAM) provides better functional density to store one bit of information than a latch or flip/flop.

### DESCRIPTION OF THE DRAWINGS

FIG. 1 is a functional diagram of a control circuit.

FIG. 2 is a flowchart of a process for framing data.

FIG. 3 is a state diagram of a SF/D4 frame state machine.

FIG. 4 is a state diagram of a modified SF/D4 frame state machine.

FIG. 5 is a state diagram of an ESF frame state machine.

FIG. 6 is a state diagram of a SLC-96 frame state machine.

FIG. 7 is a state diagram of an J1 frame state machine.

FIG. 8 is a state diagram of an E1 frame state machine.

FIG. 9 is a block diagram of a computer system on which the process of FIG. 2 may be implemented.

### DESCRIPTION

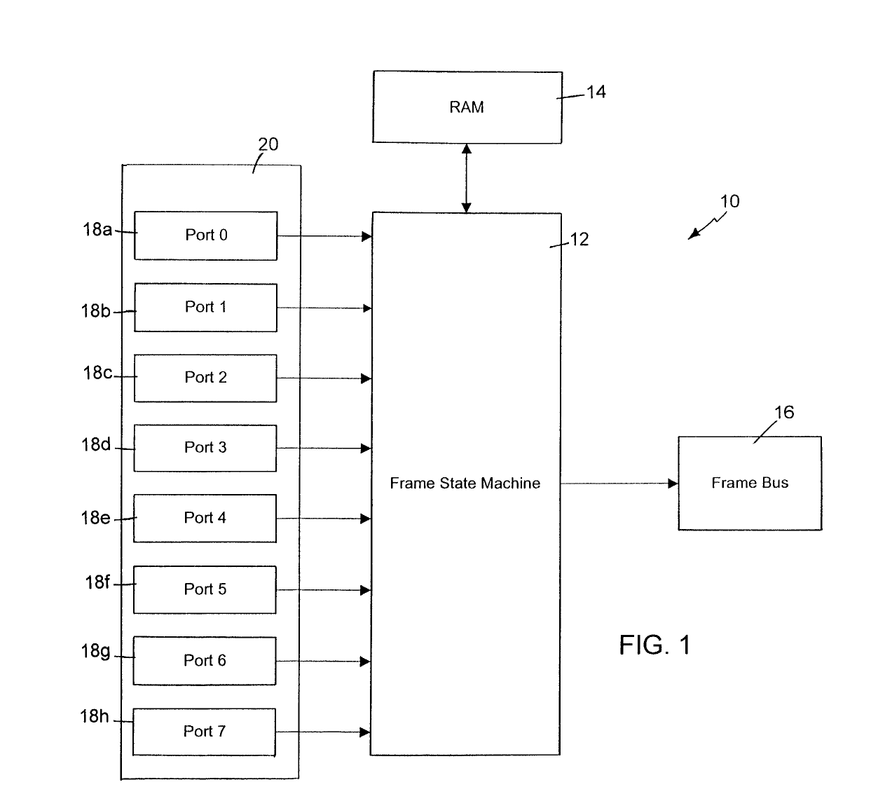

Referring to FIG. 1, a control circuit 10 increases its functional density by having a frame state machine (FSM) 12, in a time division multiplexing (TDM) mode, store logic states in a random access memory (RAM) 14. Control circuit 10 also includes a cluster 20 that transmits an n-bit data stream, where n>1. As will be explained below, FSM 12 performs a two-stage framing process to determine if the n-bit data stream is synchronized. In the first stage of the process, FSM 12 compares a portion of the n-bit data stream to a key sequence. The key sequence is a series of 1's and 0's such as 00110111001 that FSM 12 searches for to determine synchronization. When the key sequence is found, FSM 12 further analyzes the n-bit data stream for synchronization in a second stage. Once FSM 12 has determined that the n-bit data stream is synchronized, a synchronized data stream is transmitted to a frame bus 16.

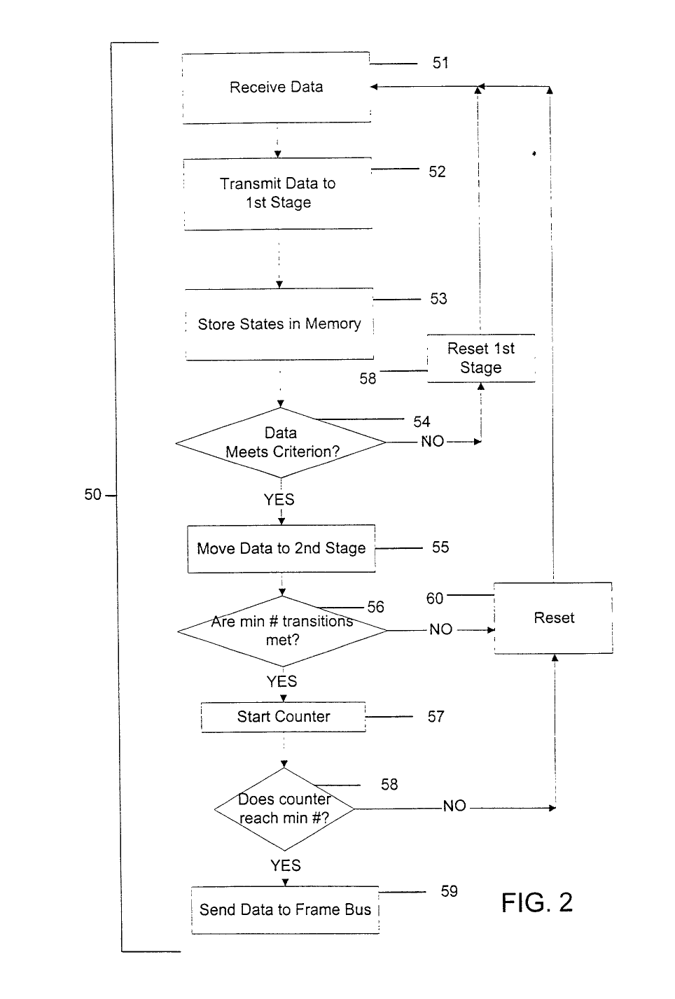

Referring to FIG. 2, in general, a process 50 determines if an incoming data stream is synchronized. Process 50 supports T1, J1 and E1 protocols, for example. Process 50 performs two stages of checks to determine if the incoming data stream is synchronized. Within a second stage, process 50 determines a synchronization after a two-step check. Once the data is synchronized, FSM 12 transmits the data to frame bus 16.

In more detail, process 50 receives (51) data from cluster 20. The data is sent to FSM 12 from eight ports 18a-18h in cluster 20. FSM 12 processes the data from cluster 20 one port at a time.

In this embodiment, the eight ports 18a-18h process the data at 2.048 or 1.544 Megabits per second (Mb/s). With an internal clock speed of 33 MHz, FSM 12 can take up to 16 cycles to process one bit per port. If processing a bit requires a read cycle, a write cycle and a few process cycles, then control circuit 10 can process 8 bits in parallel and still allow for sufficient bandwidth.

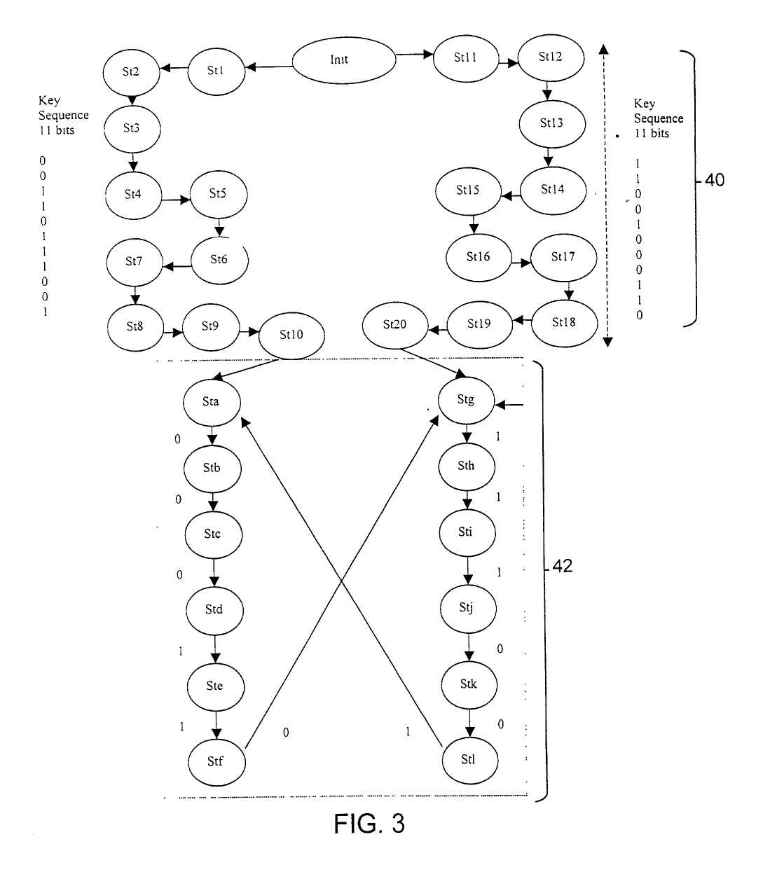

Referring to FIGS. 2 and 3, process 50 transmits (52) the data to a first stage 40 (FIG. 3) of FSM 12. Process 50 stores (53) logic states (e.g., St1, St2, Sta, etc.) in RAM 14. Logic states record the bit sequence in the bit stream.

RAM 14 is designed to be minimized in size but maximized in use. For example, to process eight bits in parallel and, if each bit requires 5 bits to represent a state, then RAM 14 has a width of 40 bits. Therefore, the size of RAM 14 is 1K×40 bits.

Process 50 determines (54) if a portion of the data received matches a key sequence. The key sequence is a predetermined bit pattern used in communications between a transmitter and a receiver. The portion of data examined includes the first m bits of the n-bit data stream, where n≧m. By looking at a portion of the data stream, control circuit 10 saves processing time by not waiting to process the entire n bits to determine if there is synchronization.

For example, FSM 12 is looking for a key sequence of 00110111001. Starting at initial state, Init, FSM 12 does not go to St1 unless a 0 is received. FSM 12 does not go to the next state, St2, unless the next bit is 0. FSM 12 goes to state, St3, when the third bit is a 1. If the data does not match the sequence at any state, process 50 resets (58) by going to state, Init. Following the diagram, FSM does not go to state, Sta, unless the sequence 00110111001 is transmitted. In other words, if the first m bits of the n-bit data stream matches the sequence, process 50 moves (55) the data stream into a second stage 42 (FIG. 3) of processing to check the data stream and further determine if the n-bit data stream is synchronized.

FSM 12 may search for more than one sequence. For example, in FIG. 3, a second sequence, 11001000110 is searched for by FSM 12 through states st11-stg.

In second stage 42, process 50 determines (56) if FSM 12 proceeds through a minimum amount of logic states. If so, the data stream is pre-synchronized or in a “pre-synch” condition. In other words, the n-bit data stream is pre-synchronized if the bit passes through k states where k>1. For example, in FIG. 3, when the FSM 12 goes from state, Stf, to state, Stg or from state, St1, to state, Sta, the FSM 12 goes through 6 states. If k states are not reached process 50 resets (60) by returning to state, Init.

When the “pre-synch” condition is declared, process 50 starts (57) a counter to check the remaining bits for synchronization. Process 50 checks (58) to see if the counter reaches a predetermined number. If the counter does not reach the predetermined number process 50 resets (60). When the counter reaches the predetermined number without resetting an “in-synch” condition exits.

The counter is used for one bit and not the entire n bits in the data stream. As long as the data is synchronized, the processing remains in the second stage in a loop pattern. The amount of bits to check before declaring that a data stream is synchronized is programmable to either 10 or 24. In this embodiment, no other bit should be in second stage 42 prior to the “pre-synch” condition. However this might not always be the case, since some patterns in the data stream can match for several bits the frame alignment sequence. These false matches are called mimic patterns. In order to decrease mimic patterns for T1 cases, for example, the user can select 24 bits as the number of bits FSM 12 must check before declaring that the n-bit data stream is synchronized. In this embodiment, 24 bits is a default value. In other situations, an optional value of waiting 10 bits can be selected instead of waiting 24 bits. By waiting 10 bits, process 50 allows for faster synchronization times. However, waiting for 10 bits to be processed comes at the risk of declaring synchronization on a mimic pattern. In other embodiments, a cycle redundancy check (CRC) (e.g., CRC-6, CRC-4) performed as a final check can further validate if the data is properly synchronized.

If the n-bit data stream is determined to be synchronized or in an “in-synch” condition, process 50 sends (59) the synchronized data to frame bus 16. Frame bus 16 is a TDM frame bus that contains information on the state of the data stream, time slot information, mode of operation, and alarms associated with the data the data stream.

Control circuit 10 is adapted to various bus modes and transport protocols. Control circuit 10 synchronizes to 2.048 Mbps and 1.544 Mbps. Examples of the various modes include the following.

T1 SF/D4:

For the T1 superframe (SF)/D4 format with 12 frames, process 50 searches for Ft, a framing toggle or a framing terminal, and Fs, a framing signal, to determine synchronization. Framing toggle, Ft, equals 101010 for odd frames (1, 3, 5, 7, 9, 11) and framing signal, Fs, equals 001110 for even frames (2, 4, 6, 8, 10, 12). When combined a framing alignment signal of 100011011100 is formed. The maximum reframe time is 50 ms. The reframe time is the interval between the instant at which a valid frame alignment signal is available at FSM 12 and the instant at which frame alignment signal is established. In other words, it is the time that the first bit is detected until synchronization is declared. The average reframe time is 7 ms. FSM 12 can search for Ft only or Ft and Fs combined when determining synchronization.

T1 ESF:

In the T1 extended superframe (ESF), a synchronization frame delineates 24 DS1 frames. T1 ESF requires less frequent synchronization than the T-carrier S4/D4 format, which frees overhead bits for on-line, real-time testing, and monitoring of circuit parameters. ESF also facilitates nonchannelized operation and clear-channel operation.

In the T1 ESF format with 24 frames, process 50 searches for a framing signal, Fe, before moving to the second stage. Fe=001011 on frames 4, 8, 12, 16, 20, 24. The maximum reframe time is 15 ms. CRC-6 may be optionally used as the final check to declare that a data stream synchronized. The average reframe time is 14 ms.

T1 SLC-96:

In the T1 subscriber loop carrier 96 (SLC-96) format with 72 frames, Ft=101010 for the odd frames (1, 3, 5, 7, 9, 11, . . . ) and Fs=001110 for frames 2, 4, 6, 8, 10, 12, 14, 16, 18, 20, 22 and 72. Fs on frames 24 to 70 have a derived data link (DDL). Four spoiler bits are defined on frames 46, 48, 50, 70 as 0101. The maximum reframe time is 50 ms. The average reframe time is 21 ms. FSM 12 searches for Ft and Fs and the spoiler bits to determine synchronization.

E1:

For the E1 mode, the frame alignment signal (FAS) is 0011011 for bits 2, 3, 4, 5, 6, 7, 8 on frames 0, 2, 4, 6, . . . and no frame alignment signal (NFAS) is 1 for bit 2 on odd frames 1, 3, 5, . . . . In CRC multiframe (MF) (CRC-MF), 001011 are the first bit for frames 1, 3, 5, 7, 9, and 11. In channel associated signaling multiframe (CAS-MF), the multiframe alignment word is 0000 for bits 1, 2, 3, and 4 of TS16.

J1 SF

In the J1 SF mode with 12 frames, framing toggle, Ft, is 101010 for odd frames 1, 3, 5, 7, 9, 11 and framing signal, Fs, is 00111 on even frames 2, 4, 6, 8, 10. The bit in frame 12 is used as a data link (DL). The maximum reframe time is 50 ms. The average reframe time is 7 ms. FSM 12 searches for Ft and Fs.

J1 ESF:

In the J1 ESF mode with 24 frames, frame alignment signal, Fe, is 001011 on frames 4, 8, 12, 16, 20, 24. The maximum reframe time is 15 ms. FSM 12 checks the Fe bits to determine synchronization. CRC-6 may be used as a final check to declared that the data stream is synchronized. The average reframe time is 14 ms.

In particular, the framing structures have the following frame state machines for each of the modes.

T1 SF/D4:

Referring to FIG. 3, the T1 SF/D4 frame structure has 12 frames with a pattern defined by the sequence of bits Ft and Fs where Ft=101010 and Fs=001110. The Ft bits are in the odd frames (1, 3, 5, 7, 9, 11) and the Fs bits are in the even frames (2, 4, 6, 8, 10, 12). The framing alignment sequence is thus 100011011100. The sequence appears from left to right in the stream. The key sequences to search to determine if the n-bit signal is a pre-synchronized sequence are Path1=00110111001 and Path2=11001000110. Path1 and Path2 are arbitrary sequences started at different point in the frame alignment sequence.

Once either Path1 or Path2 is found, another check is done in the second stage. The minimum number of bits to match in the first and second stages before declaring a “pre-sync” mode is 16 bits when Ft and Fs are checked or 8 bits when Ft only is checked.

In this format, since five bits are used, FSM 12 has 2⁵ or 32 states. If there are 193 bits per frame in T1, then every port requires a memory of 193×5 bits.

Once the key sequence is found, FSM 12 enters in the main loop sequence (second stage 42). When FSM 12 transitions from state, STF, to state, STG or state, STL, to state, STA, a “pre-sync” condition is declared and the counter is loaded with 17 in the bit where this condition is found. If FSM 12 does not leave the main loop sequence (second stage 42) and the counter reaches 20 or 48 (according to the parameter defined by the user), the “in-sync” condition is declared.

If the synchronization is lost then the search for a new synchronization starts by first checking a bit different than the one previously found to be the “in-sync” condition. This is necessary to avoid any false patterns which will lock-up FSM 12. All the bits are verified even if a “pre-sync” state has been declared for any of them. This allows FSM 12 to recover from a missed selection. Since a true bit will be in second stage 42 when the miss is declared for the false match, then the true bit will be the next to be selected.

T1 S4/D4 Modified:

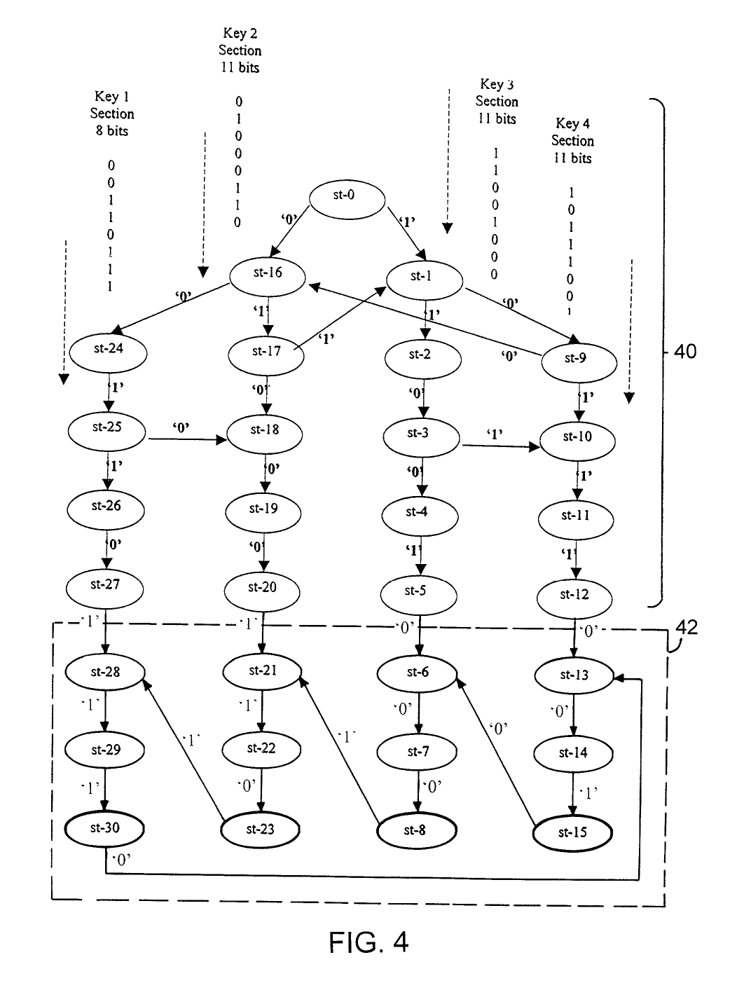

Referring to FIG. 4, the drawback to synchronization of T1 S4/D4 format is that it requires the device to be synchronized in 20 bits where it may take up to 25 bits to synchronize. Since the search for the key sequences split the 12 bit pattern in two parts, FSM 12 misses the first bit. FSM 12 has to wait until it finds the next key sequence to start the synchronization process. A faster approach would be to split the 12-bit pattern into four paths or key sequences. Each key sequence starts at a different point in the frame alignment sequence. This provides a worst case of 23 bits to synchronize.

T1 ESF:

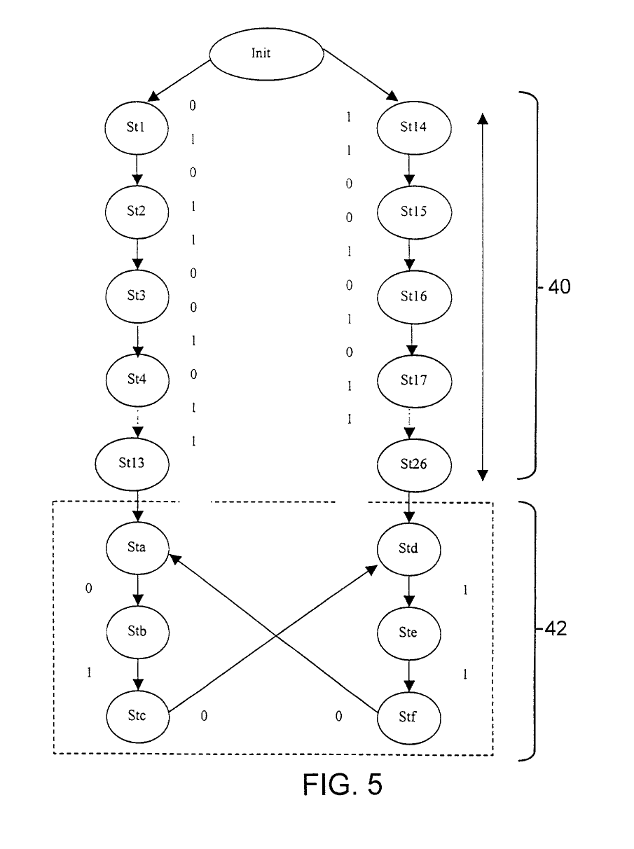

Referring to FIG. 5, the T1 ESF multiframe includes 24 frames. The framing bits are located in positions 4, 8, 12, 16, 20, and 24 and Fe=001011. Similar to the SF case, the key sequences have first to be found before entering the second stage. The key sequences to search for are arbitrarily chosen to be Path1=0101100101100 and Path2=1100101100101. Where Path1 and Path2 repeat Fe starting at different points in the Fe sequence.

Once either sequence is found, another check in the second stage is performed. The minimum number of bits to match in the first and second paths is 14 bits before declaring the “pre-sync” mode. At the “pre-synch” mode, a counter is started, if no other bit is in the same stage, and the final check for the additional bits, to complete 10 framing alignment signals or 24 frame alignments signals. If the sequence matches, then the “in-sync” condition is declared for that bit position. In order to avoid getting “in-sync” conditions for false frame alignment signals, the 24 bits sequence check is preferred as the default value as mentioned above.

T1 ESF:

In the T1 ESF mode, five bits are used by FSM 12 to search for a pattern. If T1 has 193 bits per frame, then every port requires four memory modules of 193×5 bits. Since 2^{N} sizes are used, 4 sections of 256 locations of 5 bits each per port are used. Once the key sequence is found, FSM 12 enters the second stage. When FSM 12 transitions from state, STC, to state, STD, or from state, STF, to state, STA, after 24 bits are programmed, a “pre-sync” condition is declared and the counter is loaded with 14 in the bit where this condition is found. If FSM 12 does not leave the second stage, processing and the counter reaches 14 or 24 (according to the parameter defined by the user), the “in-sync” condition is declared.

If the synchronization is lost, then the search for the new synchronization state starts by first checking a bit different from the one previously found to be “in-sync.” This avoids false patterns which will lock-up FSM 12.

T1 SLC-96:

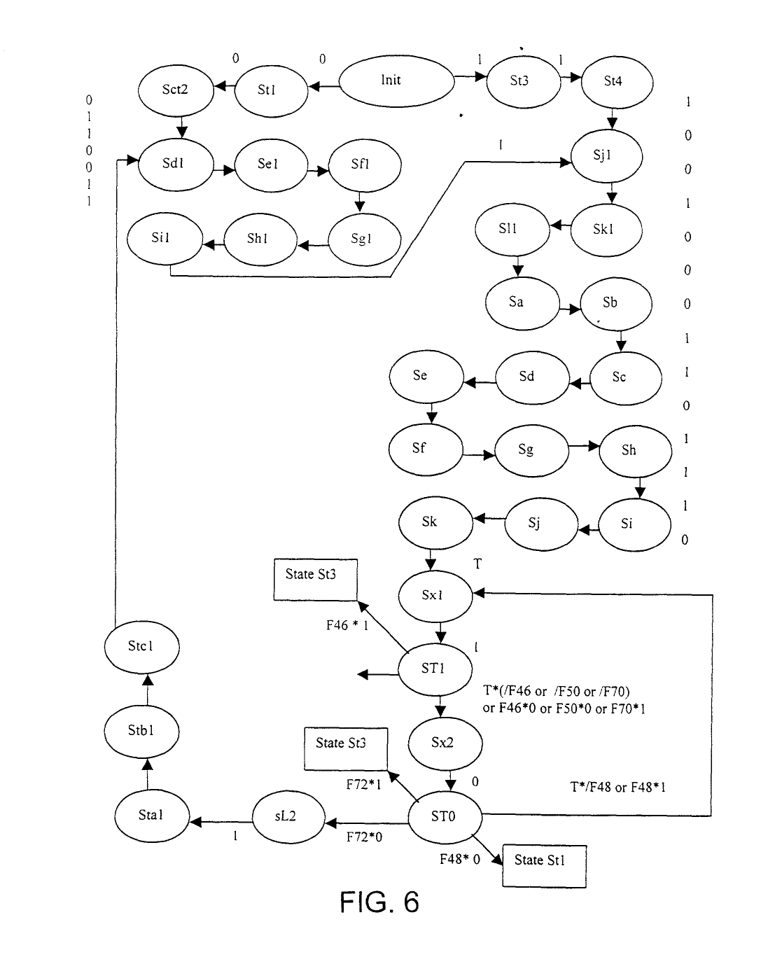

Referring to FIG. 6, the T1 SLC-96 mode has the same sequence as D4 SF mode but for a longer 72 frame structure. Some of the bits used for Fs are reserved. A twelve bit sequence is repeated two times in the first frames (1 to 23), with a last bit being used for other purposes. The last bit can be found in the frame number 72.

Ft=101010 for odd frames 1, 3, 5, 7, 9, . . . , and 71 and Fs=001110 only on frames 2, 4, 6, 8, 10, 12, 14, 16, 18, 20, 22 and 72. The framing alignments sequence is 100011011100 from frame 1 onward. Two key sequences will be searched before entering the second stage. The key sequences are Path1=000 and Path2=111. Once the process enters the second stage,the remaining bits to complete one frame are checked. When a complete frame has been checked and the first 24 framing bits of the next frame are verified to be correct, then “in-synch” is declared.

J1 12:

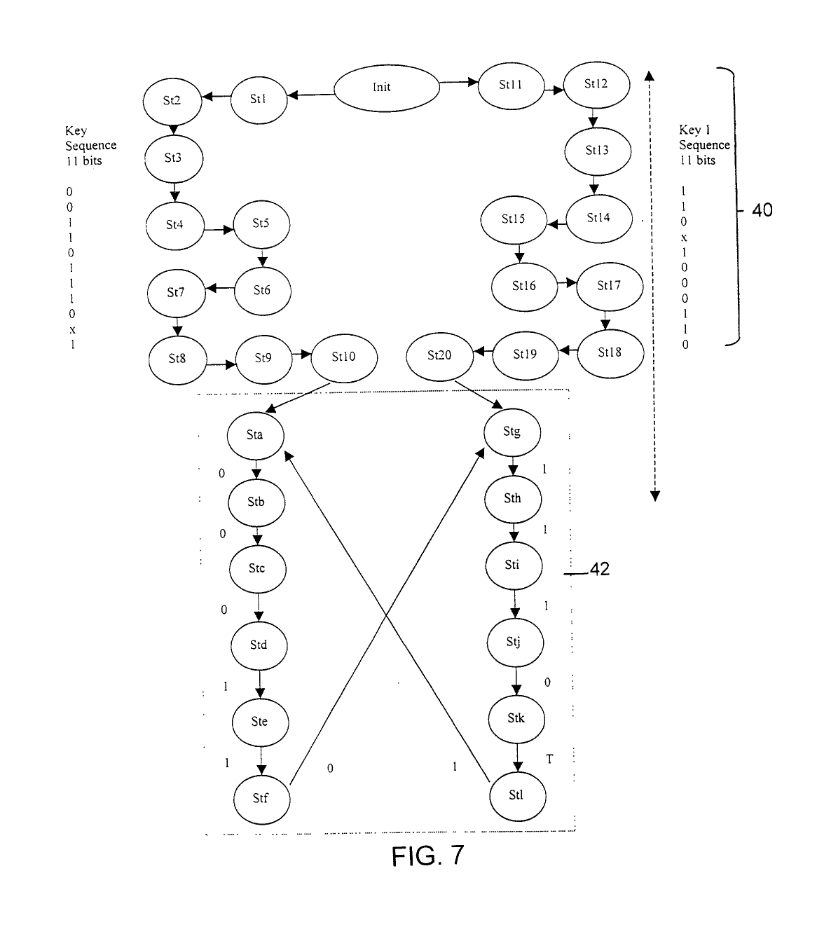

Referring to FIG. 7, the J1 12 frame multiframe has a pattern defined by the sequence of bits Ft and Fs where Ft=101010 and Fs=00111x where x can be either a ‘1’ or a ‘0’. Ft bits are in the odd frames: 1, 3, 5, 7, 9, 11 and Fs bits are in the even frames: 2, 4, 6, 8 and 10. The frame alignment sequence is thus 10001101110x. The sequence appears from left to right in the data stream.

The key sequences to search are Path1=001101110x1 and Path2=110x1000110 where Path1 and Path2 are arbitrarily chosen at different starting points in the frame alignment signal. Once either key sequence is found, another check is performed in the second stage. The minimum number of bits to match in the first and second sequences is 16 bits (Ft+Fs) before declaring a “pre-synch” condition. At the “pre-synch” condition, a counter is started. A final check for the additional 4 bits, to complete 10 frame alignment signals, or 32 bits to complete 24 frame alignment signals is started. If the counter reaches the predetermined number, then the “in-sync” state is declared for that bit position.

In other words, five bits are used for the state machine that searches for this pattern so that every port requires a memory of 193×5 bits. Once the key sequence is found, FSM 12 analyzes the data in the second stage. After the transitions from state STF→STG or STL→STA, a “pre-sync” condition is declared and the counter is loaded with 17 in the bit where the condition is found. If FSM 12 does not leave the second stage and the counter reaches 20 or 48 (according to the parameter defined by the user), the “in-sync” condition is declared.

If the synchronization is lost then the search for the new synchronization state starts first by checking a bit different from the one previously found to be “in-sync.” This avoids accepting any false patterns which will lock-up the FSM 12.

J1 24:

The J1 24 frame multiframe is the same as the T1 ESF multiframe. The difference is in the calculation of CRC-6, which includes the actual Fe bits.

FAS/NFAS:

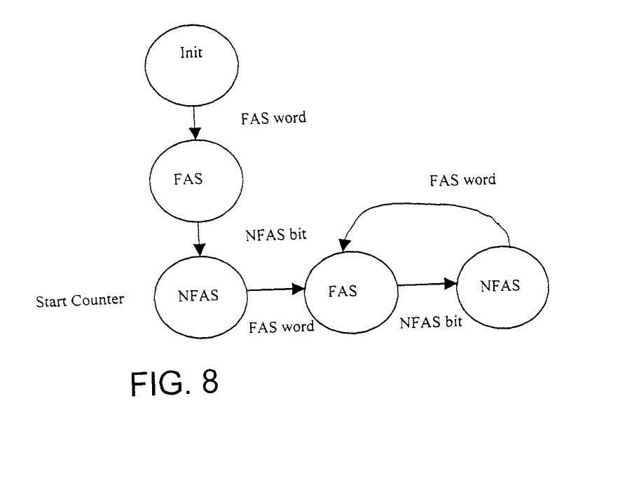

Referring to FIG. 8, in the frame alignment signal/not frame alignment signal (FAS/NFAS) structure the sequences that FSM 12 searches for are FAS where the 7-bit pattern is “0011011” from bit 2 to 8 in the time slot 0, and NFAS where a ‘1’ is in bit 2. FSM 12 will search for N consecutive FAS and/or NFAS sequences. There is a FAS detector and a NFAS detector. A counter will indicate the position of the sequence. This frame structure does not have a CRC-4 information, so no further validation is performed. FSM 12 checks 16 bits at a time that include the 8 bits just being received plus the previous 8 bits, so that FSM 12 can detect the FAS word in any bit position.

If a FAS hit is detected the position is stored and a check of the position +256, to find the NFAS bit. If it is found, then a check for FAS in the next +256 bit position is searched. If it is found then “in-synch” mode is declared. The “in-synch” mode will be lost if three consecutive incorrect FAS words are received. In other embodiments three consecutive incorrect NFAS bits are received in error before the “in-synch” mode is lost.

In order to avoid a false FAS, the next search for synchronization must be started in the bit position following the last FAS found.

E1 CRC-4:

In a E1 CRC-4 framing mode, the system first searches for the FAS/NFAS structure. FAS has the 7-bit pattern “0011011” from bit 2 to 8 in the time slot 0 and NFAS has a ‘1’ is in bit 2. FSM 12 first searches for a Basic Frame Alignment (BFA) and then looks for the CRC multiframe (CRC-MF) sequence.

FSM 12 will search for a consecutive FAS and NFAS and FAS sequence (FAS→NFAS→FAS). FAS and NFAS are detected by a FAS detector and another NFAS detector. A counter will indicate the position of the sequence. After the BFA “in-synch” mode is declared, the search for multiframe FAS CRC is started. In other embodiments, CRC-4 inter-working is also considered in this case.

The CRC-MF sequence to search is “001011xx” in bit 1 of the NFAS frames of the 16 frames multiframe. The multiframe FAS CRC has to be found and then another multiframe FAS CRC has to be found such that it is separated at x*2 ms and before the 8 ms timer expires where x>0. If the CRC multiframe is not found in 8 ms after BFA has been found, a search for BFA in a parallel sync engine is restarted in the position of the current one plus one to avoid the synchronization on the same false frame signal. If a new BFA is found and then the CRC-MF is found, then the new position is declared as the valid frame alignment signal.

CRC-4 is checked and if the number of CRC-4 errors exceed the threshold (915 in a 1000 window), then a new search for BFA is started.

CRC inter-working with non-CRC equipment can be enabled also. In this case, if after 400 ms, CRC-MF is not found, then the other equipment is assumed to not support CRC-MF. In this cases the E bits are set to 0 in the Tx direction and searching for CRC-MF is disabled.

Bit 1 of the NFAS frames is stored in a location of 8 bits that is preloaded with “11111111” and a search for the pattern “001011xx” is started. The bits are input and shifted from least significant bit (LSB) to most significant bit (MSB) (right to left). Once two patterns are detected, CRC multiframe alignment is declared. The 8 ms counter, that is equal to 4 multiframes or 16×4=64 frames, is started after BFA is declared. The counter will generate a time-out after 8 ms. This approach takes an average of 6 ms to achieve synchronization. Once CRC-MF is achieved, a counter of CRC-MF word errors is started. Any errors on that sequence are counted.

Once BFA is achieved, a check for CRC is performed. A counter of the number of CRC nibbles received is started. A counter of bad CRC received is also started. If in a window of 1000 there are 915 or more errors in CRCs then the search for BFA is re-started. The search for BFA must always be started one bit position after the last detected frame signal, in order to avoid getting in-sync with a false pattern.

If BFA is lost, then CRC-MF is lost. If CRC-MF errors are found then (optionally) the search for CRC multiframe is restarted. The device will allow a configuration of N error bits in a window of M bits in the multiframe word to be checked and if errors are found then a search for new CRC MF is started.

E1 CAS:

In E1 CAS framing, the system has to first to find the FAS/NFAS structure. FAS has a 7-bit pattern “0011011” from bit 2 to 8 in the time slot 0 and NFAS has a “1’ in bit 2. FSM 12 will search for 3 consecutive FAS and/or NFAS sequences. A FAS detector and a NFAS detector detects these signals. A counter will indicate the position of the sequence. The CAS multi-frame alignment word is searched at TS16 with the pattern “0000” in bits 1, 2, 3 and 4. The search for this multi-frame is started after the basic framing has been obtained. CRC-4 and CAS multi-frame function independently.

Once BFA is obtained, then the CAS multi-frame is searched by looking at the TS16 bits 1 to 4. CAS multiframe is declared when a 0000 pattern is found and the previous TS16 byte had at least a ‘1’.

Loss of CAS-MF alignment is declared when two consecutive CAS alignment signals are detected in error. In other embodiments, loss of CAS-MF can be declared if all the bits in TS16 are zeros for the complete MF.

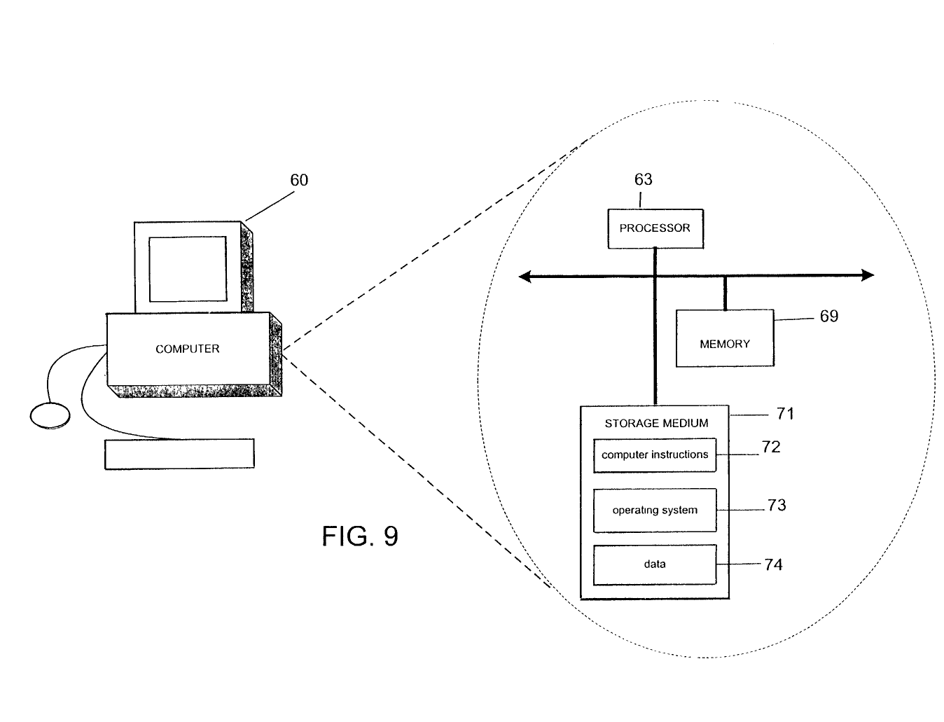

FIG. 9 shows a computer 60 for framing data using process 50 for FIGS. 3-7. Computer 60 includes a processor 63 for processing states, a memory 69, and a storage medium 71 (e.g., hard disk). Storage medium 71 stores operating system 73, data 74 which defines the framing protocols, and computer instructions 72 which are executed by processor 33 out of memory 39 to perform process 50.

Process 50 is not limited to use with the hardware and software of FIG. 9; it may find applicability in any computing or processing environment and with any type of machine that is capable of running a computer program. Process 50 may be implemented in hardware, software, or a combination of the two. Process 50 may be implemented in computer programs executed on programmable computers/machines that each include a processor, a storage medium/article readable by the processor (including volatile and non-volatile memory and/or storage elements), at least one input device, and one or more output devices. Program code maybe applied to data entered using an input device to perform process 50 and to generate output information.

Each such program may be implemented in a high level procedural or objected-oriented programming language to communicate with a computer system. However, the programs can be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform process 50. Process 50 may also be implemented as a machine-readable storage medium, configured with a computer program, where upon execution, instructions in the computer program cause the computer to operate in accordance with process 50.

The invention is not limited to the specific embodiments described herein. Other I/O interfaces can be used instead of the mouse (e.g., a keyboard, trackball, input tablet, joystick). The invention is not limited to the specific processing order of FIG. 2. Rather, the blocks of FIG. 2 may be re-ordered, as necessary, to achieve the results set forth above.

Other embodiments not described herein are also within the scope of the following claims.

What is claimed is:

1. A method comprising:
receiving data from a series of network ports;
transmitting the data to a first stage of a frame state machine;
determining if the data includes a key sequence; and
moving the data from the first stage of the frame state machine to a second stage of the frame state machine if the data has the key sequence.

2. The method of claim 1, further comprising storing a plurality of states of the frame state machine in a memory.

3. The method of claim 2, wherein receiving the data from the series of network ports includes receiving the data from one port at a time.

4. The method of claim 1, wherein the frame state machine uses a time division multiplexing technique.

5. The method of claim 1, wherein the data includes a sequence of n bits, where n>1 and the criterion includes a sequence of m bits, where n≧m

6. The method of claim 5, wherein determining if the data has the key sequence includes comparing the first m bits of the sequence of n bits of the data to the sequence of m bits of the criterion.

7. The method of claim 6, wherein if the frame state machine transitions k (k>1) states in the second stage then the data is pre-synchronized.

8. The method of claim 7, further comprising:
starting a counter when the data is pre-synchronized;
checking to see if the data is synchronized; and
performing a cyclic redundancy check (CRC).

9. The method of claim 8, further comprising sending the data from the frame state machine to a frame bus, the frame bus being a time division multiplexing bus.

10. The method of claim 2, wherein the memory is random access memory.

11. An apparatus comprising:
a memory that stores executable instructions; and
a processor that executes the instructions to:
receive data from a series of network ports;
transmit the data to a first stage of a frame state machine;
determine if the data includes a key sequence; and
move the data from the first stage of the frame state machine to a second stage of the frame state machine if the data has the key sequence.

12. The apparatus of claim 11, further comprising instructions to store a plurality of states of the frame state machine in a memory.

13. The apparatus of claim 12, wherein receiving the data from the series of network ports includes receiving the data from one port at a time.

14. The apparatus of claim 11, wherein the frame state machine uses a time division multiplexing technique.

15. The apparatus of claim 11, wherein the data includes a sequence of n bits, where n>1 and the criterion includes a sequence of m bits, where n≧m.

16. The apparatus of claim 15, wherein determining if the data has the key sequence includes comparing the first m bits of the sequence of n bits of the data to the sequence of m bits of the criterion.

17. The apparatus of claim 16, wherein if the frame state machine transitions k (k>1)states in the second stage then the data is pre-synchronized.

18. The apparatus of claim 17, further comprising instructions to:
start a counter when the data is pre-synchronized;
check to see if the data is synchronized; and
perform a cyclic redundancy check (CRC).

19. The apparatus of claim 11, further comprising instructions to send the data from the frame state machine to a frame bus, the frame bus being a time division multiplexing bus.

20. The apparatus of claim 12, wherein the memory is random access memory.

21. An article comprising a machine-readable medium that stores executable instructions for framing data in a control circuit, the instructions causing a machine to:
receive data from a series of network ports;
transmit the data to a first stage of a frame state machine;
determine if the data has a key sequence; and
move the data from the first stage of the frame state machine to a second stage of the frame state machine if the data has the key sequence.

22. The article of claim 21, further comprising instructions causing the machine to store a plurality of states of the frame state machine in a memory.

23. The article of claim 22, wherein receiving the data from the series of network ports includes receiving the data from one port at a time.

24. The article of claim 21, wherein the frame state machine uses a time division multiplexing technique.

25. The article of claim 21, wherein the data includes a sequence of n bits, where n>1 and the criterion includes a sequence of m bits, where n≧m.

26. The article of claim 15, wherein determining if the data has the key sequence includes comparing the first m bits of the sequence of n bits of the data to the sequence of m bits of the criterion.

27. The article of claim 16, wherein if the frame state machine transitions k (k>1) states in the second stage then the data is pre-synchronized.

28. The article of claim 17, further comprising instructions causing the machine to:
start a counter when the data is pre-synchronized;
check to see if the data is synchronized; and
perform a cyclic redundancy check (CRC).

29. The article of claim 21, further comprising instructions causing the machine to send the data from the frame state machine to a frame bus, the frame bus being a time division multiplexing bus.

30. The article of claim 22, wherein the memory is random access memory.
